(19) United States
(12) Patent Application Publication
(10) Pub. No.: US 2019/0359920 A1
(43) Pub. Date: Nov. 28, 2019

(54) Method for Manufacturing Beverage and Method for Improving Flavor of Beverage

(71) Applicant: Sapporo Breweries Limited, Tokyo (JP)

(72) Inventors: Mitsuhiro Uemoto, Tokyo (JP); Kiyoshi Takoi, Tokyo (JP); Atsushi Tanigawa, Tokyo (JP); Koichiro Koie, Tokyo (JP); Yutaka Itoga, Tokyo (JP)

(73) Assignee: Sapporo Breweries Limited, Tokyo (JP)

(21) Appl. No.: 16/480,893

(22) PCT Filed: Dec. 26, 2017
(86) PCT No.: PCT/JP2017/046743

§ 371 Date: Jul. 25, 2019

(30) Foreign Application Priority Data
Jan. 26, 2017 (JP) 2017-011904

(51) Int. Cl. C12G 3/06; C12C 3/00

(52) U.S. Cl. CPC C12G 3/06; C12C 3/00

(57) ABSTRACT

Provided are a method of producing a beverage having an improved flavor and a method of improving a flavor of a beverage. The method of producing a beverage includes using a raw material containing hops harvested on a day 51 days or more from flowering. The method of improving a flavor of a beverage includes using, in production of a beverage using a raw material containing hops, as the hops, hops harvested on a day 51 days or more from flowering, to thereby improve a flavor of the beverage.

### TECHNICAL FIELD

The present invention relates to a method of producing a beverage and a method of improving a flavor of a beverage.

### BACKGROUND ART

In Patent Literature 1, there is a description of a beverage containing two or more kinds of monoterpene alcohols and 4-mercapto-4-methylpentan-2-one, in which a total content of the two or more kinds of monoterpene alcohols is 15 ppb or more, and in which a content of the 4-mercapto-4-methylpentan-2-one is 10 ppt or more.

In Patent Literature 2, there is a description of a method of producing a beer-taste beverage, involving adding a hop bract-containing composition having an α-acid content of less than 1 wt % of the composition in the step of producing a beer-taste beverage.

In Non Patent Literature 1, there is a description that attention should be paid to finish harvesting hops during a period of from 40 days to 50 days, including 45 days as a center, after flowering.

### CITATION LIST

### Patent Literature

[PTL 1] JP 2013-220091 A
[PTL 2] JP 2014-187969 A

### Non Patent Literature

[NPL 1] Hops Cultivation Calendar published in 2016 (published by The Iwate Hops Association, ZENNOH IWATE, and NOSAI Iwate)

### SUMMARY OF INVENTION

### Technical Problem

One of the methods of improving flavor of a beverage produced using hops may be to increase the amount of the hops used. However, when the amount of the hops used is increased, not only the flavor derived from the hops, but also bitterness derived from the hops is increased. In addition, another method may be to selectively extract a desired flavor component from the hops. However, such processing of the hops takes labor and cost.

The present invention has been made in view of the above-mentioned problem, and one of the objects of the present invention is to provide a method of producing a beverage having an effectively improved flavor, and a method of improving a flavor of a beverage.

### Solution to Problem

In order to solve the above-mentioned problem, according to one embodiment of the present invention, there is provided a method of producing a beverage, including using a raw material containing hops harvested on a day 51 days or more from flowering. According to the one embodiment of the present invention, the method of producing a beverage having an effectively improved hop-derived flavor is provided.

In addition, the hops may each contain a thiol component. In addition, the method may include producing a beverage using the raw material containing the hops, the beverage having an increased content of one or more thiol components selected from the group consisting of 3-sulfanyl-4-methylpentan-1-ol, 3-sulfanyl-4-methylpentyl acetate, and 3-sulfanyl-1-hexanol, compared to a beverage produced by the same method except for using hops harvested on a 45th day from flowering. In addition, the method may include producing a beer-taste beverage using the raw material containing the hops.

In order to solve the above-mentioned problem, according to one embodiment of the present invention, there is provided a method of improving a flavor of a beverage, including using, in production of a beverage using a raw material containing hops, as the hops, hops harvested on a day 51 days or more from flowering, to thereby improve a flavor of the beverage. According to the one embodiment of the present invention, the method of effectively improving a flavor of a beverage is provided.

### Advantageous Effects of Invention

According to the present invention, a method of producing a beverage having an improved flavor and a method of improving a flavor of a beverage are provided.

### BRIEF DESCRIPTION OF DRAWINGS

FIG. 1 is an explanatory diagram for showing the results of evaluation of beverages in Example 1 according to one embodiment of the present invention.

FIG. 2 is an explanatory diagram for showing the results of evaluation of hops in Example 2 according to one embodiment of the present invention.

### DESCRIPTION OF EMBODIMENTS

Now, one embodiment of the present invention will be described. The present invention is not limited to the embodiment.

In one aspect, a method according to one embodiment of the present invention (hereinafter referred to as “method of the present invention”) is a method of producing a beverage, including using a raw material containing hops harvested on a day 51 days or more from flowering. In another aspect, the method of the present invention is a method, including using, in production of a beverage using a raw material containing hops, as the hops, hops harvested on a day 51 days or more from flowering, to thereby improve a flavor of the beverage.

That is, the inventors of the present invention have carried out extensive investigations on technical means for improving the flavor of a beverage produced using a raw material containing hops, and as a result, have independently found that, surprisingly, the flavor of the beverage is effectively improvedby using hops harvested at a time later than a harvest time that has been considered a common general technical knowledge in the related art. Thus, the inventors have completed the present invention.

The hops harvested on a day 51 days or more from flowering are hops harvested on the 51st day from flowering or a later day. The hops to be used in the method of the present invention may be: hops harvested on a day 53 days or more from flowering; hops harvested on a day 55 days or more from flowering; hops harvested on a day 58 days or more from flowering; hops harvested on a day 60 days or more from flowering; hops harvested on a day 63 days or more from flowering; or hops harvested on a day 65 days or more from flowering.

In addition, the hops to be used in the method of the present invention are preferably hops harvested on a day within 80 days from flowering (the 80th day from flowering or an earlier day), particularly preferably hops harvested on a day within 75 days from flowering. The harvest day of the hops to be used in the method of the present invention may be specified by arbitrarily combining any one of the above-mentioned lower limit values and any one of the above-mentioned upper limit values.

In the present invention, the flowering of the hops is a time point at which flowers corresponding in number to 50% or more of the total number of flower buds of cultivated hops have bloomed. That is, for example, hops harvested on a day 51 days or more from flowering are hops harvested on a day 51 days or more from a time point at which flowers corresponding in number to 50% or more of the total number of the flower buds have bloomed.

The form of the hops is not particularly limited, and may be, for example, one or more selected from the group consisting of hop powder, hop pellets, pressedhops, rawhops, a hop extract, isomerized hops, low hops, tetra hops, and hexa hops.

The hop powder is obtained by pulverizing dried hop cones. The hop pellets are obtained by compression-molding the hop powder into pellets. The pressed hops are obtained by compressing dried hop cones. The raw hops are hops to be used without being dried after being harvested. The hop extract is obtained by extracting components contained in hop cones (for example, α-acids and/or thiol components to be described later) with a solvent. The isomerized hops are obtained by subjecting hops to isomerization treatment, such as alkali treatment or heat treatment, to isomerize α-acids. Reduced iso-α-acid products, such as low hops, tetra hops, and hexa hops, are obtained by chemically modifying iso-α-acids.

As the hops, hops each containing a thiol component are preferably used. The thiol component is an organic component having a thiol group (SH group) in the molecule. The molecular weight of the thiol component is, for example, 100 Da or more and 150 Da or less.

Specifically, as the hops, for example, hops containing one or more thiol components selected from the group consisting of 4-methyl-4-sulfanylpentan-2-one (4MSP) (also referred to as 4-mercapto-4-methylpentan-2-one), 3-sulfanyl-4-methylpentan-1-ol (3SMP) (also referred to as 3-mercapto-4-methylpentan-1-ol), 3-sulfanyl-4-methylpentyl acetate (3SMPA) (also referred to as 3-mercapto-4-methylpentyl acetate), 3-sulfanyl-1-hexanol (3SH) (also referred to as 3-mercapto-1-hexanol), and 3-sulfanylhexyl acetate (3SHA) (also referred to as 3-mercaptohexyl acetate) may be used, hops containing one or more thiol components selected from the group consisting of 4MSP, 3SMP, 3SMPA, and 3SH are preferably used, and hops containing one or more thiol components selected from the group consisting of 3SMP, 3SMPA, and 3SH are particularly preferably used.

4MSP contributes to a green-like aroma. 3SMP contributes to a citrus-like aroma. 3SMPA contributes to a rhubarb-like aroma. 3SH contributes to a passion fruit-like aroma. 3SHA contributes to a grapefruit-like aroma.

The hops to be used in the method of the present invention may be hops having an increased content (content per unit dry weight of the hops (for example, μg/kg)) of one or more thiol components selected from the group consisting of 3SMP, 3SMPA, and 3SH, compared to the case of being harvested on the 45th day from flowering.

In this case, the hops to be used in the method of the present invention may be hops having the content of one or more thiol components selected from the group consisting of 3SMP, 3SMPA, and 3SH increased by 5% or more, preferably 10% or more, compared to the case of being harvested on the 45th day from flowering.

Further, the hops to be used in the method of the present invention may be hops having the content of 3SMP increased by 15% or more, preferably 20% or more, more preferably 25% or more, particularly preferably 30% or more, compared to the case of being harvested on the 45th day from flowering.

In addition, in the method of the present invention, as described above, a beverage having an effectively improved flavor is produced by using hops harvested at a later time than in the related art. The improved flavor of the beverage produced in the method of the present invention is, for example, one or more flavors selected from the group consisting of a citrus-like aroma, freshness, and lightness, as demonstrated in Examples described later. In addition, it is considered that, as shown in Examples described later, changes in contents of specific thiol components derived from the hops contribute to the improvement in flavor of the beverage according to the method of the present invention.

That is, the method of the present invention may include producing a beverage having an increased content (content per unit volume of the beverage (for example, ng/L)) of one or more thiol components selected from the group consisting of 3SMP, 3SMPA, and 3SH, compared to a beverage produced by the same method except for using hops harvested on the 45th day from flowering.

In this case, in the method of the present invention, there may be produced a beverage having the content of one or more thiol components selected from the group consisting of 3SMP, 3SMPA, and 3SH increased by 5% or more, preferably 10% or more, more preferably 15% or more, particularly preferably 20% or more, compared to a beverage produced by the same method except for using hops harvested on the 45th day from flowering.

Further, in the method of the present invention, there may be produced a beverage having the content of 3SMP increased by 50% or more, preferably 100% or more, more preferably 150% or more, particularly preferably 200% or more, compared to a beverage produced by the same method except for using hops harvested on the 45th day from flowering.

In addition, in the method of the present invention, there may be produced a beverage having the content of 3SMPA increased by 50% or more, preferably 100% or more, more preferably 150% or more, and particularly preferably 200% or more, compared to a beverage produced by the same method except for using hops harvested on the 45th day from flowering.

In addition, in the method of the present invention, the flavor of the beverage may be improved without a large increase in bitterness unit (BU) of the beverage. The bitterness unit is used as an indicator of the degree of bitterness of beer. The bitterness unit is measured in accordance with a method described in the literature (“Methods of Analysis of BCOJ (Enlarged and Revised Edition) (2013), edited by Brewery Convention of Japan (Analysis Committee), Brewers Association of Japan, published by The Brewing Society of Japan,” “7.12 Bitterness Unit” or “8.15 Bitterness Unit (IM)”).

That is, the method of the present invention may include producing a beverage having an increased ratio of the content of one or more thiol components selected from the group consisting of 4MSP, 3SMP, 3SMPA, and 3SH to the bitterness unit (one or more ratios selected from the group consisting of a 4MSP/BU ratio, a 3SMP/BU ratio, a 3SMPA/BU ratio, and a 3SH/BU ratio), compared to a beverage produced by the same method except for using hops harvested on the 45th day from flowering.

In this case, in the method of the present invention, it is preferred to produce a beverage having one or more ratios selected from the group consisting of a 3SMP/BU ratio, a 3SMPA/BU ratio, and a 3SH/BU ratio increased, compared to a beverage produced by the same method except for using hops harvested on the 45th day from flowering.

Further, in this case, in the method of the present invention, it is preferred to produce a beverage having one or more ratios selected from the group consisting of a 3SMP/BU ratio, a 3SMPA/BU ratio, and a 3SH/BU ratio increased by 5% or more, preferably 10% or more, more preferably 15% or more, and particularly preferably 20% or more, compared to a beverage produced by the same method except for using hops harvested on the 45th day from flowering.

Further, in the method of the present invention, there may be produced a beverage having a 3SMP/BU ratio increased by 50% or more, preferably 100% or more, more preferably 150% or more, and particularly preferably 200% or more, compared to a beverage produced by the same method except for using hops harvested on the 45th day from flowering.

In addition, in the method of the present invention, there may be produced a beverage having a 3SMPA/BU ratio increased by 50% or more, preferably 100% or more, more preferably 150% or more, particularly preferably 200% or more, compared to a beverage produced by the same method except for using hops harvested on the 45th day from flowering.

In the method of the present invention, the beverage is produced using a raw material liquid prepared using a raw material containing the hops. The preparation of the raw material liquid includes at least mixing the hops and water. Specifically, for example, a raw material liquid prepared by using a raw material containing the hops and boiling a mixed liquid containing the hops and water is used.

When the mixed liquid containing the hops and water is boiled, α-acids contained in the hops are isomerized to produce iso-α-acids to impart bitterness. However, the extraction of thiol components contained in the hops (for example, one or more selected from the group consisting of 4MSP, 3SMP, 3SMPA, and 3SH) does not require the boiling (that is, the thiol components contained in the hops are extracted by mixing the hops and water even when the boiling is not performed). Therefore, the preparation of the raw material liquid may, but does not necessarily, include boiling the mixed liquid containing the hops and water.

For this reason, in the method of the present invention, a timing at which the hops are added is not particularly limited. That is, for example, even when boiling is performed during the preparation of the raw material liquid, the timing is not limited to being during the boiling, and the hops may be added after the boiling. Therefore, so-called late hopping and/or dry hopping may be performed.

In the method of the present invention, hops harvested at the same time as in the related art may be further used in addition to the above-mentioned hops harvested at a later time than in the related art. In this case, the ratio of the usage amount of the hops harvested at a later time than in the related art to the total amount of the hops to be used in the method of the present invention (total of the usage amount of the hops harvested at a later time than in the related art, and the usage amount of the hops harvested at the same time as in the related art) may be 20 wt % or more (20 wt % or more and 100 wt % or less) on a dry weight basis, and is preferably 30 wt % or more, particularly preferably 50 wt % or more.

In the method of the present invention, a raw material containing the hops and a plant raw material may be used. The plant raw material is not particularly limited as long as the plant raw material is a plant-derived raw material for use in the production of a beverage. The plant raw material preferably contains, for example, one or more selected from the group consisting of the following items (i), (ii), and (iii): (i) one or more selected from the group consisting of grains (for example, one or more selected from the group consisting of barley and a barley-like plant, rice, and corn), beans, and potatoes; (ii) a product obtained by germinating one or more selected from the group of item (i); and (iii) a component derived from item (i) and/or item (ii).

Specifically, for example, in the method of the present invention, there may be used a raw material liquid prepared using a raw material containing: the hops; and barley and a barley-like plant and/or a product obtained by germinating the barley and the barley-like plant (malt). The barley and the barley-like plant are preferably one or more selected from the group consisting of barley, wheat, oats, and rye. The malt is preferably malt of one or more selected from the group consisting of barley, wheat, oats, and rye.

The component of item (iii) is not particularly limited as long as the component is derived from the plant raw material of item (i) and/or the plant raw material of item (ii). The component of item (iii) is, for example, one or more selected from the group consisting of proteins, peptides, amino acids, saccharides, lipids, vitamins, and minerals.

In the method of the present invention, there may be used a raw material liquid prepared through saccharification using the raw material containing the hops and the plant raw material. The saccharification is performed by treating a mixed liquid containing the plant raw material and water with a polysaccharide degrading enzyme and/or a protein degrading enzyme. The polysaccharide degrading enzyme and/or the protein degrading enzyme may be an enzyme contained in the plant raw material (for example, malt) and/or may be an enzyme which is externally added separately from the plant raw material. The saccharification is performed at a temperature (for example, 30° C. or more and 80° C. or less) that allows the polysaccharide degrading enzyme and/or the protein degrading enzyme to act. In addition, in the method of the present invention, there may be used a raw material liquid prepared through saccharification and boiling using the raw material containing the hops and the plant raw material.

The method of the present invention may include adding yeast to the raw material liquid to perform alcoholic fermentation. In this case, a fermentation liquid after the alcoholic fermentation is subjected to predetermined treatment (for example, filtration treatment and/or heat treatment) to finally provide the beverage.

When the alcoholic fermentation is performed, the raw material liquid contains a carbon source and a nitrogen source each of which can be utilized by the yeast irrespective of whether or not the plant raw material is used. The carbon source is not particularly limited as long as the carbon source is a compound containing a carbon atom and can be utilized by the yeast. The carbon source is, for example, a saccharide that can be utilized by the yeast.

The saccharide contains, for example, one or more kinds selected from the group consisting of glucose, fructose, sucrose, maltose, and maltotriose.

The nitrogen source is not particularly limited as long as the nitrogen source is a compound containing a nitrogen atom and can be utilized by the yeast. The nitrogen source is, for example, an amino acid and/or a peptide. In this case, the raw material liquid may contain an enzymatically degraded product of a protein as the amino acid and/or the peptide. The enzymatically degraded product of a protein is obtained by degrading a protein with a protein degrading enzyme, and the product contains the amino acid and/or the peptide.

The density of the yeast in the fermentation liquid at the time of the start of the alcoholic fermentation is not particularly limited. The density is, for example, preferably from 1×10⁶ cells/mL to 3×10⁹ cells/mL. The yeast is not particularly limited as long as the yeast performs alcoholic fermentation. The yeast is preferably, for example, one or more selected from the group consisting of beer yeast, wine yeast, shochu yeast, and sake yeast.

The conditions of the alcoholic fermentation are not particularly limited as long as the alcoholic fermentation is performed by the yeast in the fermentation liquid under those conditions. The alcoholic fermentation is performed by, for example, keeping the fermentation liquid at a temperature in the range of from 0° C. or more to 40° C. or less for a period of time of from 1 day or more to 14 days or less.

In the method of the present invention, the beverage may be produced without alcoholic fermentation (i.e., the method of the present invention may not include performing alcoholic fermentation). In this case, the beverage is obtained using the raw material liquid without alcoholic fermentation. Specifically, the beverage is obtained by, for example, subjecting the raw material liquid to one or more selected from the group consisting of addition of another component, filtration treatment, and heat treatment. The other component to be added to the raw material liquid is, for example, one or more selected from the group consisting of saccharides, dietary fiber, acidulants, dyes, flavoring agents, sweeteners, and bittering agents.

The beverage to be produced in the method of the present invention is not particularly limited, and for example, a sparkling beverage may be produced. The sparkling beverage is a beverage having foam properties including a foam-forming property and a foam-stability. That is, it is preferred that the sparkling beverage be, for example, a beverage containing carbon dioxide gas and having: a foam-forming property for forming a foam layer on the top of a liquid surface when poured into a container, such as a glass; and a foam-stability for holding the formed foam for a certain period of time or longer.

The carbon dioxide gas pressure of the sparkling beverage may be 1.0 kg/cm² or more, or 2.0 kg/cm² or more. The upper limit value of the carbon dioxide gas pressure of the sparkling beverage is not particularly limited, and the carbon dioxide gas pressure may be 3.0 kg/cm² or less.

In addition, the sparkling beverage may have a NIBEM value of 50 seconds or more. The NIBEM value is evaluated as a period of time (seconds) required for reducing the height of foam, which is formed when the sparkling beverage is poured into a predetermined container, by a predetermined amount. Specifically, the NIBEM value of the sparkling beverage is measured in accordance with a method described in the literature: “Methods of Analysis of BCOJ (Enlarged and Revised Edition) (2013) (edited by Brewery Convention of Japan (Analysis Committee), Brewers Association of Japan, publishing office: The Brewing Society of Japan),” “8.29 Foam-Foam-stability Measurement Method using NIBEM-T”.

In the method of the present invention, the sparkling beverage may be produced through alcoholic fermentation. When the sparkling beverage is produced without alcoholic fermentation, the sparkling beverage is obtained by imparting foam properties by, for example, use of carbonated water and/or use of carbon dioxide gas.

In the method of the present invention, an alcoholic beverage may be produced. The alcoholic beverage is a beverage having an alcohol content of 1 vol % or more (alcohol percentage of 1% or more). The alcohol content of the alcoholic beverage is not particularly limited as long as the alcohol content is 1 vol % or more. The alcohol content may be, for example, 1 vol % or more and 20 vol % or less.

In the method of the present invention, the alcoholic beverage may be produced through alcoholic fermentation. When the alcoholic beverage is produced without alcoholic fermentation, for example, an alcohol (for example, ethanol) is added to the raw material liquid. The alcoholic beverage may be a sparkling alcoholic beverage.

In the method of the present invention, a non-alcoholic beverage may be produced. The non-alcoholic beverage is a beverage having an alcohol content of less than 1 vol %. The alcohol content of the non-alcoholic beverage is not particularly limited as long as the alcohol content is less than 1 vol %. The alcohol content may be, for example, less than 0.5 vol %, less than 0.05 vol %, or less than 0.005 vol %.

In the method of the present invention, the non-alcoholic beverage may be produced without alcoholic fermentation. When the non-alcoholic beverage is produced through alcoholic fermentation, the non-alcoholic beverage is obtained by, for example, subjecting the fermentation liquid after the alcoholic fermentation to treatment for reducing the alcohol content. The non-alcoholic beverage may be a sparkling non-alcoholic beverage.

In the method of the present invention, a beer-taste beverage may be produced. In this embodiment, the beer-taste beverage is a sparkling beverage having a beer-like flavor.

The beer-taste beverage may be a sparkling alcoholic beverage. Specifically, the beer-taste beverage may be, for example, beer, low-malt beer, or a sparkling alcoholic beverage containing low-malt beer and an alcohol component (for example, spirits). In addition, the beer-taste beverage may be a sparkling non-alcoholic beverage. That is, the beer-taste beverage is not particularly limited as long as the beer-taste beverage is a sparkling beverage having a beer-like flavor irrespective of its alcohol content, whether or not malt is used, and whether or not there is alcoholic fermentation during its production.

Next, specific Examples according to the embodiment of the present invention will be described.

### Example 1

Beer was produced as a beverage. A total of four kinds of hops were used: hops of the Furano Beauty variety harvested 45 days or 65 days after flowering, and hops of the Furano Magical variety harvested 45 days or 65 days after flowering.

First, a mixed liquid obtained by mixing barley malt with water was saccharified. Subsequently, 0.8 kg/kL of hops (specifically, hop powder) of one kind out of the four kinds were added to the mixed liquid after the saccharification, and the resultant was boiled. Further, the mixed liquid after the boiling was cooled to provide a raw material liquid. After that, beer yeast was added to the raw material liquid to perform alcoholic fermentation, and the resultant was matured. The fermentation liquid after the maturation was subjected to treatments including filtration to provide beer having an alcohol content of about 5 vol %.

Then, the four kinds of beverages obtained as described above were each subjected to a sensory test by five experienced panelists. In the sensory test, three items, namely “citrus-like aroma”, “freshness”, and “lightness”, were evaluated. Specifically, a relative score was defined as a score where “3” is given to each of the items of the beverage produced using the hops of the Furano Beauty variety harvested 45 days after flowering, and then each of the panelists gave the relative score of 1, 2, 3, 4, or 5 for each of the items of each of the other beverages. A higher score was given for a stronger flavor of each item.

In addition, for each of the beverages, a bitterness unit (BU) and the contents of four kinds of thiol components (4MSP, 3S4MP, 3S4MPA, and 3SH) were measured. The contents of the thiol components (4MSP, 3S4MP, 3S4MPA, and 3SH) in each of the beverages were quantified as described below.

That is, first, the thiol components contained in each of the beverages were extracted with dichloromethane, and then the thiols were specifically purified using a commercially available cartridge for pretreatment (MetaSep IC-Ag, manufactured by GL Sciences Inc.), followed by measurement by GC/MS/MS.

In addition, the thiol components may be measured by, for example, a method obtained by appropriately changing the measurement conditions of a quantification method for thiol compounds based on two-dimensional GC-MS used in Example 1 of JP 2014-211433 A to conditions suited for 4MSP, 3S4MP, 3S4MPA, and 3SH. In this case, in order to make an adjustment so as to have a repeatability of less than CV15% and/or a detection limit lower than half a quantitative value, for example, one or more selected from the group consisting of the following may be changed: the conditions of solvent extraction in the preparation of a sample; the kind of solid phase (for example, a solid phase having silver fixed thereto); the washing conditions of the solid phase; elution conditions including the kind of eluent; a washing method for removing an elution reagent; a GC column; the temperature conditions of an oven; various conditions regarding injection; a GC flow volume; and the conditions of an MS detector. In addition, GC/MS/MS may be used in place of two-dimensional GC-MS.

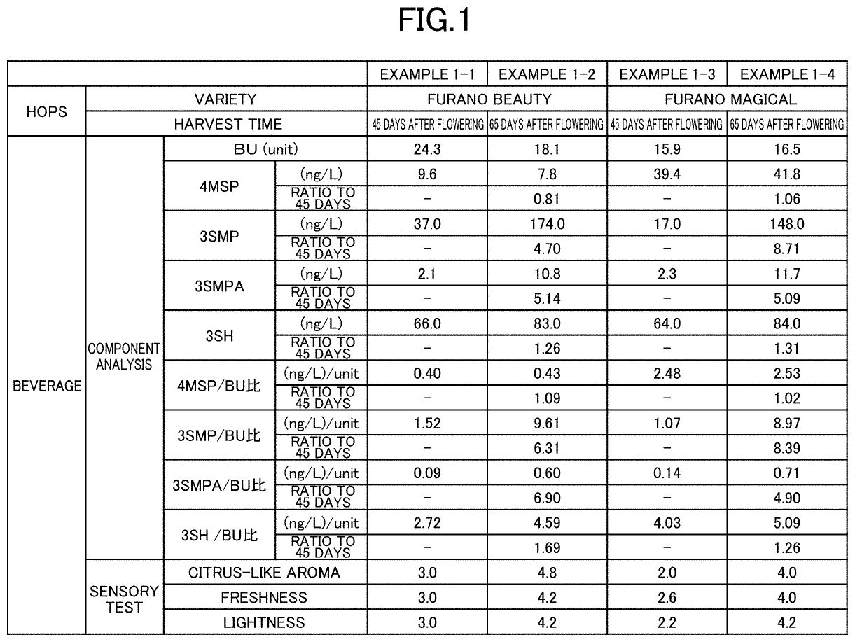

In FIG. 1, for each of the four kinds of beverages (Example 1-1 to Example 1-4), the variety and harvest time of the hops used in its production, and the results of the component analysis and the sensory test, are shown. In FIG. 1, the “ratio to 45 days” of each of the thiol components (4MSP, 3SMP, 3SMPA, and 3SH) represents the ratio of the content of the thiol component in the beverage obtained using the hops harvested on the 65th day from flowering (“65 days after flowering”) to the content of the thiol component in the beverage obtained using hops harvested on the 45th day from flowering (“45 days after flowering”). In addition, the “ratio to 45 days” of the ratio of each of the thiol component contents to the BU (a 4MSP/BU ratio, a 3SMP/BU ratio, a 3SMPA/BU ratio, and a 3SH/BU ratio) represents the ratio of the ratio of the beverage obtained using the hops harvested on the 65 day from flowering (“65 days after flowering”) to the ratio of the beverage obtained using the hops harvested on the 45 day from flowering (“45 days after flowering”).

As shown in FIG. 1, in the sensory test, in each of the case of using the hops of the Furano Beauty variety and the case of using the hops of the Furano Magical variety, the beverages obtained using the hops harvested 65 days after flowering (Example 1-2 and Example 1-4) were given remarkably high scores for all of the “citrus-like aroma”, the “freshness”, and the “lightness” compared to the beverages obtained using the hops harvested 45 days after flowering (Example 1-1 and Example 1-3). That is, it was confirmed that the use of the hops harvested 65 days after flowering remarkably improved the flavors of the beverages compared to the case of using the hops harvested 45 days after flowering.

In addition, as shown in FIG. 1, in each of the case of using the hops of the Furano Beauty variety and the case of using the hops of the Furano Magical variety, the BU of the beverages was not remarkably increased by the use of the hops harvested 65 days after flowering compared to the use of the hops harvested 45 days after flowering. That is, the use of the hops harvested 65 days after flowering did not significantly enhance the bitterness of the beverages compared to the use of the hops harvested 45 days after flowering.

Meanwhile, with regard to the contents of the thiol components in the beverages, the contents of 3SMP, 3SMPA, and 3SH in the beverages obtained using the hops harvested 65 days after flowering (Example 1-2 and Example 1-4) were increased to be 1.26 or more times (increased by 26% or more) as large as those in the beverages obtained using the hops harvested 45 days after flowering (Example 1-1 and Example 1-3).

In particular, the contents of 3SMP and 3SMPA in the beverages obtained using the hops harvested 65 days after flowering (Example 1-2 and Example 1-4) were remarkably increased to be from 4.70 times to 8.71 times as large as those in the beverages obtained using the hops harvested 45 days after flowering (Example 1-1 and Example 1-3).

In addition, the ratios of the thiol component contents to the BU of the beverages (the 4MSP/BU ratio, the 3SMP/BU ratio, the 3SMPA/BU ratio, and the 3SH/BU ratio, obtained by dividing the thiol component contents by the BU) were increased by the use of the hops harvested 65 days after flowering compared to the use of the hops harvested 45 days after flowering in each of the case of using the hops of the Furano Beauty variety and the case of using the hops of the Furano Magical variety.

In particular, the 3SMP/BU ratios and 3SMPA/BU ratios of the beverages obtained using the hops harvested 65 days after flowering (Example 1-2 and Example 1-4) were remarkably increased to be from 4.90 times to 8.39 times as large as those of the beverages obtained using the hops harvested 45 days after flowering (Example 1-1 and Example 1-3).

### Example 2

The contents of α-acids and thiol components (4MSP, 3S4MP, 3S4MPA, and 3SH) were measured for a total of nine kinds of hops, i.e., the four kinds of hops used in Example 1 described above, hops of the Furano Beauty variety harvested 55 days after flowering, hops of the Furano Magical variety harvested 55 days after flowering, and hops of the Cascade variety harvested 45 days, 65 days, or 75 days after flowering.

The α-acid content of the hops was obtained by measuring the total content of α-acids (total of the content of cohumulone, the content of humulone, and the content of adhumulone) using HPLC in accordance with a method described in the literature (Analytica-EBC, 7.7 α- and β-Acids in Hops and Hop Products by HPLC (1997)).

The contents of the thiol components (4MSP, 3S4MP, 3S4MPA, and 3SH) in the hops were quantified as described below. That is, the thiol components in the hops were measured as follows: 2 g of hop powder was extracted with dichloromethane, and then the thiols were specifically purified using a commercially available cartridge for pretreatment (MetaSep IC-Ag, manufactured by GL Sciences Inc.), and measurement by GC/MS/MS was performed. In addition, the thiol components may be measured by, for example, a method obtained by appropriately changing the measurement conditions of a quantification method for thiol compounds based on two-dimensional GC-MS used in Example 1 of JP 2014-211433 A to conditions suited for 4MSP, 3S4MP, 3S4MPA, and 3SH. In this case, in order to make an adjustment so as to have a repeatability of less than CV15% and/or a detection limit lower than half a quantitative value, for example, one or more selected from the group consisting of the following may be changed: the conditions of solvent extraction in the preparation of a sample; the kind of solid phase (for example, a solid phase having silver fixed thereto); the washing conditions of the solid phase; elution conditions including the kind of eluent; a washing method for removing an elution reagent; a GC column; the temperature conditions of an oven; various conditions regarding injection; a GC flow volume; and the conditions of an MS detector. In addition, GC/MS/MS may be used in place of two-dimensional GC-MS.

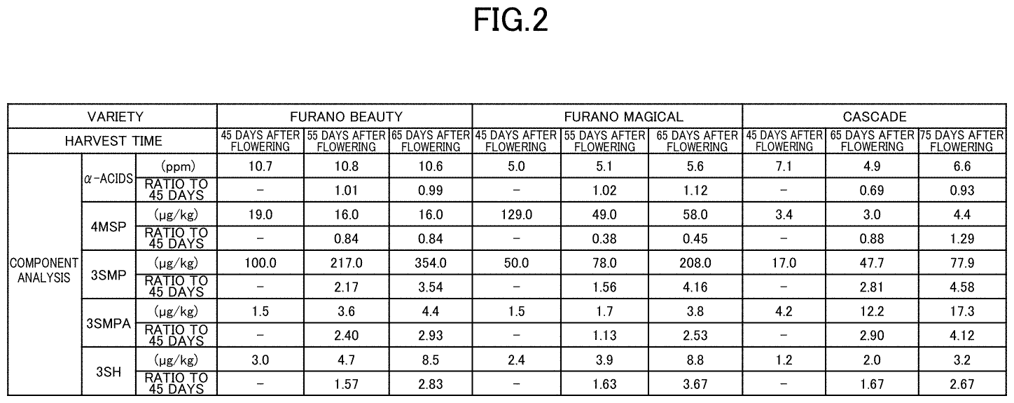

In FIG. 2, for each of the nine kinds of hops, the results of the measurement of the content (ppm) of the α-acids and the contents (lag/kg) of the thiol components (4MSP, 3S4MP, 3S4MPA, and 3SH) are shown. In FIG. 2, the “ratio to 45 days” represents the ratio of the content of the α-acids or a thiol component in a beverage obtained using the hops harvested on the 55th day, the 65th day, or the 75th day from flowering (“55 days after flowering”, “65 days after flowering”, or “75 days after flowering”) to the content of the α-acids or the thiol component in a beverage obtained using the hops harvested on the 45th day from flowering (“45 days after flowering”).

As shown in FIG. 2, the α-acid content of the hops hardly changed depending on the harvest times ranging from 45 days to 65 days after flowering in the hops of the Furano Beauty variety and the Furano Magical variety, and was confirmed to tend to reduce as the harvest time became later and later in the hops of the Cascade variety.

Meanwhile, the thiol component contents of the hops increased except for 4MSP as the harvest time became later and later from 45 days after flowering, to 55 days after flowering, to 65 days after flowering, and to 75 days after flowering in the hops of each of the Furano Beauty variety, the Furano Magical variety, and the Cascade variety.

That is, the contents of 3SMP, 3SMPA, and 3SH in the hops harvested 55 days, 65 days, or 75 days after flowering were increased to be 1.13 or more times (increased by 13% or more) (“ratio to 45 days”) as large as those in the hops harvested 45 days after flowering.

In particular, the contents of 3SMP and 3SMPA in the hops harvested 55 days, 65 days, or 75 days after flowering were remarkably increased to be from 1.56 times to 4.58 times as large as those in the hops harvested 45 days after flowering.

1. A method of producing a beverage, comprising using a raw material containing hops harvested on a day 51 days or more from flowering.

2. The method of producing a beverage according to claim 1, wherein the hops each contain a thiol component.

3. The method of producing a beverage according to claim 1, wherein the method comprises producing a beverage using the raw material containing the hops, the beverage having an increased content of one or more thiol components selected from the group consisting of 3-sulfanyl-4-methylpentan-1-ol, 3-sulfanyl-4-methylpentyl acetate, and 3-sulfanyl-1-hexanol, compared to a beverage produced by the same method except for using hops harvested on a 45th day from flowering.

4. The method of producing a beverage according to claim 1, wherein the method comprises producing a beer-taste beverage using the raw material containing the hops.

5. A method, comprising using, in production of a beverage using a raw material containing hops, as the hops, hops harvested on a day 51 days or more from flowering, to thereby improve a flavor of the beverage.
